(19) United States
(12) Patent Application Publication
(10) Pub. No.: US 2024/0114913 A1
(43) Pub. Date: Apr. 11, 2024

(54) ARTICLE INSPECTION SYSTEM

(71) Applicant: ANRITSU CORPORATION, Kanagawa (JP)

(72) Inventors: Eiji ASAI, Kanagawa (JP); Eiji TSUJIMURA, Kanagawa (JP); Toshiaki KIKUCHI, Kanagawa (JP)

(21) Appl. No.: 18/478,456

(22) Filed: Sep. 29, 2023

(30) Foreign Application Priority Data
Oct. 6, 2022 (JP) 2022-161480

(51) Int. Cl. A22C 17/00; A22C 21/00

(52) U.S. Cl. CPC A22C 17/0086; A22C 21/0053; A22C 21/0069; G01N 23/083; G01N 2223/618; G01N 2223/643; G01N 2223/652

(57) ABSTRACT

There is provided an article inspection system including: an additional processing control unit that executes additional processing on an article determined to be defective among inspected articles, according to an inspection result of an article inspection unit, in which the additional processing control unit includes a quality state determination unit that determines which one of a plurality of preset quality states the inspection result corresponds to, and processing request selection means for selecting any one of first processing request information for requesting a working machine to perform first additional processing work by the working machine and second processing request information for requesting second manual additional processing work, according to a determination result of the quality state determination unit.

### TECHNICAL FIELD

The present invention relates to an article inspection system, and more particularly to an article inspection system including an article inspection unit and an additional processing control unit that executes additional processing on an inspected article according to the inspection result.

### BACKGROUND ART

In the related art, there is known an article inspection system that sequentially inspects transported articles within a predetermined range in a transport direction and in a direction orthogonal to the transport direction, and executes additional processing on the articles to exclude a specific article or portion having the failed inspection result, for ensuring an appropriate quality state of production articles.

For example, there is another article inspection system provided with cutting-out means capable of acquiring, by incorporating an X-ray inspection system into a production line, position information on a foreign substance based on the detected image data, and cutting out and partially removing a foreign substance-contaminated portion from raw meat, watered flour, or the like (see Patent Document 1, for example).

In addition, there is known still another article inspection system in which an X-ray analyzer detects a foreign substance such as a fragment of bone in food pieces and specifies coordinates of the foreign substance, when the foreign substance passes through a gap region between specific conveyors, a water jet is applied from a water eject nozzle located above the foreign substance to remove the foreign substance while perforating the food pieces, with a water eject cutting tool assembly that operates based on information on the coordinates, (see Patent Document 2, for example).

Further, there is an apparatus including X-ray inspection means for inspecting food transported by a conveyor with X-rays in an inspection region to determine whether or not the food is an acceptable product, a plurality of distributing means arranged on a side of the conveyor downstream side than the X-ray inspection region and capable of alternately discharging a failed product out of a transport path, and a plurality of worktables provided corresponding to the plurality of distributing means, in which while the failed product is evenly distributed on each worktable, an operator can perform correction processing on the failed product discharged to each worktable (for example, removing bones from chicken) to improve a safety level of the food (see Patent Document 3, for example).

### RELATED ART DOCUMENT

### Patent Document

[Patent Document 1] Japanese Patent No. 5524598
[Patent Document 2] Japanese Patent No. 6660894
[Patent Document 3] Japanese Patent No. 6412034

### DISCLOSURE OF THE INVENTION

### Problem that the Invention is to Solve

Meanwhile, in the article inspection system in the related art as described in Patent Documents 1 and 2 described above, as requirements for safety of the food and the like becomes more sophisticated, only with the mechanical additional processing such as cutting-out or perforating by a working machine, the additional processing may not be sufficient or omission in the additional processing may occur depending on an occurrence mode of the defective portion. In some cases, another worker is arranged to visually check the article after the mechanical additional processing or to add manual correction processing. In some cases, a work load became large regardless of the automatic additional processing by the working machine.

Further, in the article inspection system in the related art as described in Patent Documents 1 to 3, all defective products are subjected to the additional processing by the same method regardless of a defect mode. Therefore, depending on the defect mode, there is a case where it is easy to specify a position of the defective portion in the inspected article from the inspection result information and it is easy to perform the additional processing with the working machine, but there is a lot of waste due to rough removal work using the working machine, or a case where it is possible to manually perform the additional processing without waste if the position of the defective portion in the inspected article can be specified, but the work load such as manual correction processing becomes large since the position of the defective portion cannot be easily specified only by visually inspecting the inspected article.

The present invention is made to solve the unsolved problems in the related art as described above, and an object of the present invention is to provide an article inspection system with high reliability that reduces a load required for manual checking or manual correction processing, and sufficiently reduces an additional processing load, while increasing reliability of automatic additional processing by a working machine.

### Means for Solving the Problem

According to a first aspect of the present invention, there is provided an article inspection system including: an article inspection unit that inspects a transported article; and an additional processing control unit that executes additional processing on an article determined to be defective among inspected articles, according to an inspection result of the article inspection unit, in which the additional processing control unit includes a quality state determination unit that determines which one of a plurality of preset quality states the inspection result of the article inspection unit corresponds to, and processing request selection means for selecting any one of first processing request information for requesting a working machine to perform first additional processing work by the working machine and second processing request information for requesting second manual additional processing work, according to a determination result of the quality state determination unit.

With this configuration, in the present invention, the quality state determination unit of the additional processing control unit selects which one of the plurality of preset quality states the inspection result of the article inspection unit corresponds to, and the processing request selection means determines any one of the first processing request information for requesting the working machine to perform the first additional processing work or the second processing request information for requesting the second manual additional processing work, according to the determination result of the quality state determination unit. Therefore, if the quality state can be fully handled in the automatic additional processing by the working machine, highly reliable additional processing can be executed to sufficiently reduce a load for manual additional processing. If the quality state is desirable to be manually checked, corrected, or the like, the automatic additional processing by the working machine is omitted or reduced to preliminary processing, and accurate manual additional processing can be executed with a low load.

According to a second aspect of the present invention, in the article inspection system according to the first aspect, for a plurality of inspection items which are inspectable by the article inspection unit, the processing request selection means presets a condition for selecting the first processing request information or the second processing request information. In this manner, it is possible to accurately select and set whether a priority is given to the working machine or given to the manual processing, for the request information for additional processing according to the inspection result of each of the plurality of inspection items.

According to a third aspect of the present invention, in the article inspection system according to the first aspect, when the article inspection unit detects at least an abnormality in a quality state of the article, the quality state determination unit determines which one of a plurality of defect modes the abnormality corresponds to, based on the quality state of the article. In this case, it is possible to accurately determine the defect mode corresponding to a content of the abnormality in the quality state of the defective product, and to quickly and accurately select additional processing required for the defect mode.

According to a fourth aspect of the present invention, in the article inspection system according to the second aspect, when the article inspection unit detects at least an abnormality in a quality state of the article, the quality state determination unit determines which one of a plurality of defect modes the abnormality corresponds to, based on the quality state of the article. In this case, it is possible to accurately determine the defect mode corresponding to a content of the abnormality in the quality state of the defective product, and to quickly and accurately select additional processing required for the defect mode.

According to a fifth aspect of the present invention, in the article inspection system according to the third aspect, when a foreign substance is detected in the article, the quality state determination unit determines which one of the plurality of defect modes the foreign substance corresponds to, based on a type, a size, a shape, a density, or a contamination position of the foreign substance. In this case, it is possible to accurately select a selection setting appropriate to additional processing such as partial exclusion for a defect mode including the foreign substance.

According to a sixth aspect of the present invention, in the article inspection system according to the fourth aspect, when a foreign substance is detected in the article, the quality state determination unit determines which one of the plurality of defect modes the foreign substance corresponds to, based on a type, a size, a shape, a density, or a contamination position of the foreign substance. In this case, it is possible to accurately select a selection setting appropriate to additional processing such as partial exclusion for a defect mode including the foreign substance.

According to a seventh aspect of the present invention, in the article inspection system according to the third aspect, when an excess or shortage of a content quantity of the article is detected, the quality state determination unit determines which one of the plurality of defect modes the excess or shortage of the content quantity corresponds to, based on a state of the excess or shortage of the content quantity. In this case, it is possible to quickly and accurately select additional processing appropriate to the excess or shortage of the content quantity.

According to an eighth aspect of the present invention, in the article inspection system according to the fourth aspect, when an excess or shortage of a content quantity of the article is detected, the quality state determination unit determines which one of the plurality of defect modes the excess or shortage of the content quantity corresponds to, based on a state of the excess or shortage of the content quantity. In this case, it is possible to quickly and accurately select additional processing appropriate to the excess or shortage of the content quantity.

According to a ninth aspect of the present invention, in the article inspection system according to the fifth aspect, the processing request selection means stores priority setting information for preferentially selecting any one of the first processing request information and the second processing request information, depending on which one of the plurality of different quality states occurring for each inspection item the inspection result of the article inspection unit corresponds to, in a memory. In this case, when the processing request selection means selects a request for additional processing, it is quickly and accurately determined whether a priority is given to the automatic step or to the manual step, based on the information stored in the memory for selection setting.

According to a tenth aspect of the present invention, in the article inspection system according to the sixth aspect, the processing request selection means stores priority setting information for preferentially selecting any one of the first processing request information and the second processing request information, depending on which one of the plurality of different quality states occurring for each inspection item the inspection result of the article inspection unit corresponds to, in a memory. In this case, when the processing request selection means selects a request for additional processing, it is quickly and accurately determined whether a priority is given to the automatic step or to the manual step, based on the information stored in the memory for selection setting.

According to an eleventh aspect of the present invention, in the article inspection system according to the seventh aspect, the processing request selection means stores priority setting information for preferentially selecting any one of the first processing request information and the second processing request information, depending on which one of the plurality of different quality states occurring for each inspection item the inspection result of the article inspection unit corresponds to, in a memory. In this case, when the processing request selection means selects a request for additional processing, it is quickly and accurately determined whether a priority is given to the automatic step or to the manual step, based on the information stored in the memory for selection setting.

According to a twelfth aspect of the present invention, in the article inspection system according to the eighth aspect, the processing request selection means stores priority setting information for preferentially selecting any one of the first processing request information and the second processing request information, depending on which one of the plurality of different quality states occurring for each inspection item the inspection result of the article inspection unit corresponds to, in a memory. In this case, when the processing request selection means selects a request for additional processing, it is quickly and accurately determined whether a priority is given to the automatic step or to the manual step, based on the information stored in the memory for selection setting.

According to a thirteenth aspect of the present invention, in the article inspection system according to the first aspect, when the processing request selection means selects the first processing request information, the additional processing control unit causes the working machine to execute a predetermined work operation for removing an abnormal portion of the quality state from an article of which an abnormality is detected in the quality state, and when the processing request selection means selects the second processing request information, the additional processing control unit causes a notification device to output a work request for the second manual additional processing, based on the second processing request information. In this case, it is possible to increase reliability of the additional processing by the working machine and reduce a load of the manual additional processing. Meanwhile, when a quality state requiring manual checking or manual correction processing occurs, it is possible to quickly and accurately notify an operator of the quality state.

According to a fourteenth aspect of the present invention, in the article inspection system according to the second aspect, when the processing request selection means selects the first processing request information, the additional processing control unit causes the working machine to execute a predetermined work operation for removing an abnormal portion of the quality state from an article of which an abnormality is detected in the quality state, and when the processing request selection means selects the second processing request information, the additional processing control unit causes a notification device to output a work request for the second manual additional processing, based on the second processing request information. In this case, it is possible to increase reliability of the additional processing by the working machine and reduce a load of the manual additional processing. Meanwhile, when a quality state requiring manual checking or manual correction processing occurs, it is possible to quickly and accurately notify an operator of the quality state.

In a case where the working machine is used for the additional processing such as removing or correcting a defective portion in the quality state from the defective product, not only the working machine can perform the mechanical removal operation on the defective portion, but also the working machine can perform other preliminary additional processing such as marking on the defective portion according to the first processing request information, and then main additional processing such as manual correction processing can be executed after the other preliminary additional processing or the like. In other words, the first processing request information and the second processing request information referred to in the present invention may be used for selecting automatic work by the working machine or manual work at the time of the additional processing, and accurately distributing the inspected article to the working machine or an operator. In order to improve the reliability of the additional processing and reduce the load, the additional processing may be executed by using both the preliminary processing by the working machine and the manual main processing. For example, in a case where it is not easy to visually recognize the defective portion of the inspected article that is a raw material for processed food or the like since the defective portion is not exposed on an outer surface of the article, it is also possible to facilitate the manual additional processing work, by performing cutting to expose the defective portion from the surface of the article or marking the defective portion by the preliminary additional processing work of the working machine.

### Advantage of the Invention

According to the present invention, there is provided an article inspection system capable of reducing a load such as manual checking or manual correction processing, and sufficiently reducing an additional processing load, while increasing reliability of automatic additional processing by a working machine.

### BRIEF DESCRIPTION OF THE DRAWINGS

FIG. 1 is a block diagram of a control system in an article inspection system according to one embodiment of the present invention.

FIG. 2 is a schematic system configuration diagram of the article inspection system according to the embodiment of the present invention.

FIG. 3 is a schematic system front view illustrating arrangement of an article inspection step, and an automatic step and a manual step for additional processing in the article inspection system according to the embodiment of the present invention.

FIG. 4 is an explanatory diagram of arrangement of an article inspection apparatus, a robot working machine that executes mechanical additional processing, and a worktable for executing manual additional processing in the article inspection system according to the embodiment of the present invention.

FIG. 5 is an explanatory diagram of an example of a selection setting screen on which for a processing requiring article for which additional processing such as correction processing of a quality state is required based on an article inspection result, whether to perform the mechanical additional processing or the manual additional processing can be selected according to the quality state, in the article inspection system according to the embodiment of the present invention.

FIG. 6 is a schematic block configuration diagram illustrating a signal flow of each of an article inspection unit, a control unit, and a drive output unit in the article inspection system according to the embodiment of the present invention.

FIG. 7 is a plan view of a transport section of the automatic step in which a partial exclusion work is executed on a defective portion by a robot working machine in the article inspection system according to the embodiment of the present invention.

FIG. 8 is a plan view of a transport section of the manual step in which the partial exclusion work is manually executed on the defective portion in the article inspection system according to the embodiment of the present invention.

FIG. 9 is a schematic configuration diagram of the robot working machine that executes the partial exclusion work on the defective portion in the article inspection system according to the embodiment of the present invention.

### BEST MODE FOR CARRYING OUT THE INVENTION

Hereinafter, embodiments according to the present invention will be described with reference to the drawings.

### One Embodiment

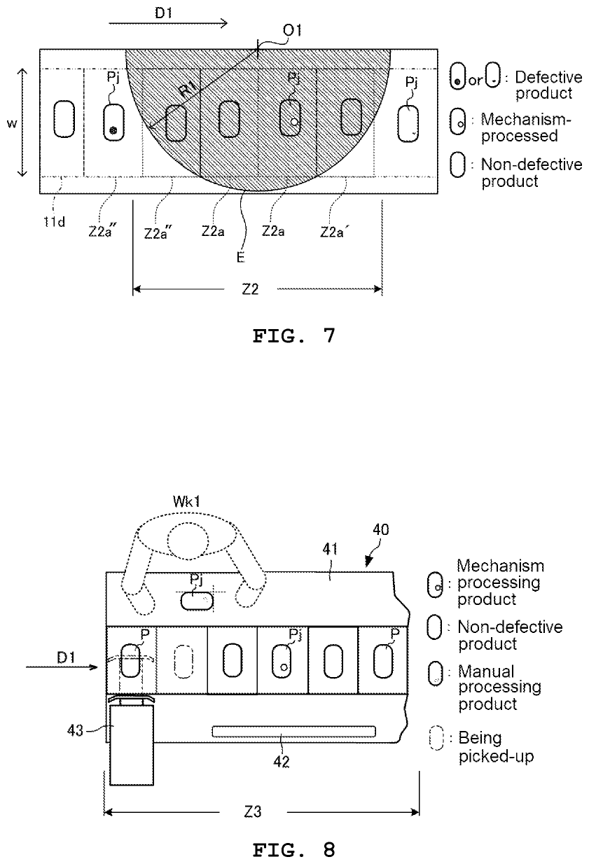

FIGS. 1 to 9 illustrate an article inspection system according to one embodiment of the present invention.

First, a configuration will be described.

As illustrated in FIGS. 1 to 5, an article inspection system 1 according to the present embodiment includes an article inspection apparatus 10 (article inspection unit) that sequentially inspects an article P being transported on an article transport path 11 such as a plurality of conveyors arranged in an article production line (not illustrated), and an additional processing control unit 20 that executes predetermined additional processing on the article P having a variation, a deviation, a defective portion, or the like in a quality state and requiring the predetermined additional processing for a correction among inspected articles P, according to an inspection result of the article inspection apparatus 10 (hereinafter, referred to as an additional processing requiring article Pj).

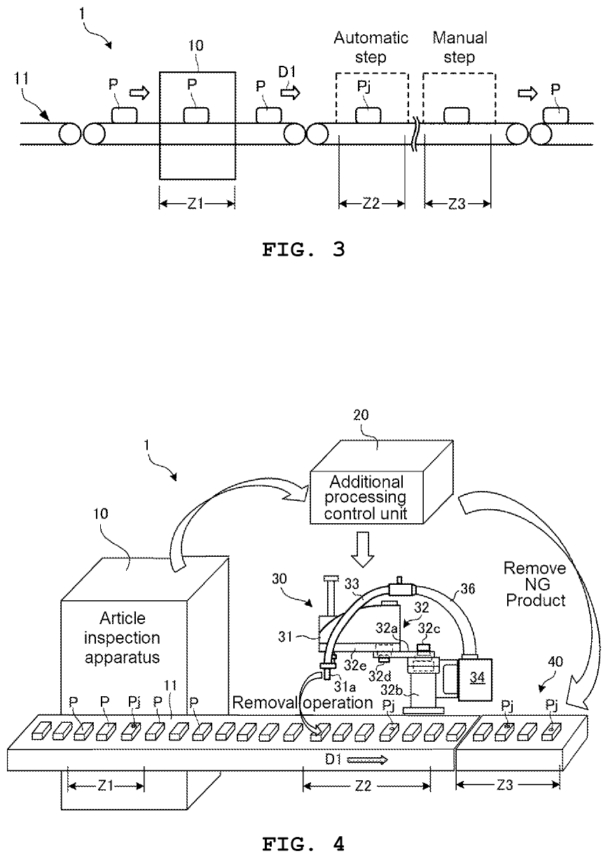

The article inspection apparatus 10 in this article inspection system 1 includes a part or all of at least one type of inspection machine capable of inspecting articles, such as an X-ray foreign substance detector, a metal detector, and a checkweigher. The article inspection apparatus 10 can inspect the quality state of each article P passing through a predetermined inspection section Z1 on the article transport path 11 in a direction D1 in FIGS. 3 and 4 by a predetermined inspection method, and determine whether, for example, the article P is an OK product, that is, a non-defective product, or an NG product, that is, a defective product based on the preset determination condition. Here, the article P is, for example, a food material, processed food, and a medicine spread or expanded in a predetermined shape on the article transport path 11, which is ingested by humans or animals, or produced as a product touched with humans or animals, and is not limited to a specific article.

The article inspection apparatus 10 also has a function of an X-ray inspection system to generate X-ray inspection image data with which a position and a range of a defective portion of an NG product can be specified by, for example, its center coordinates and radius.

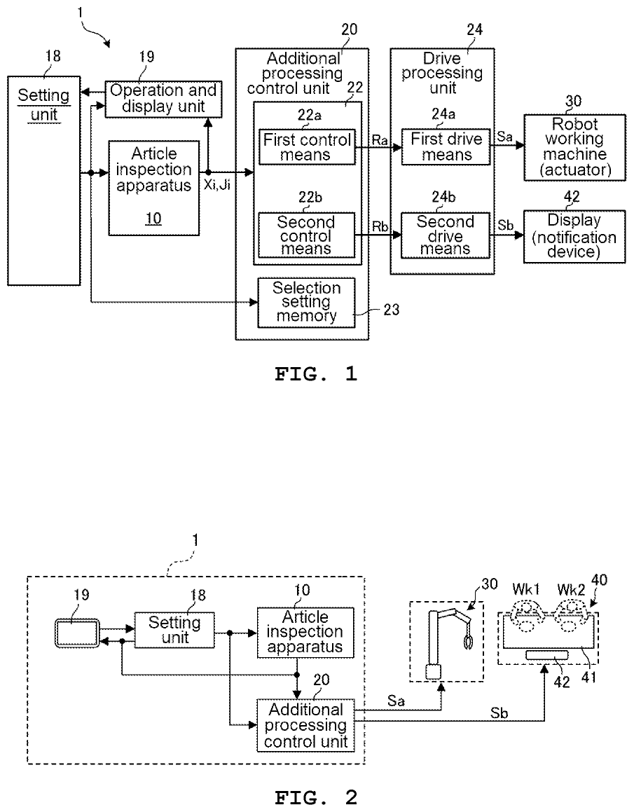

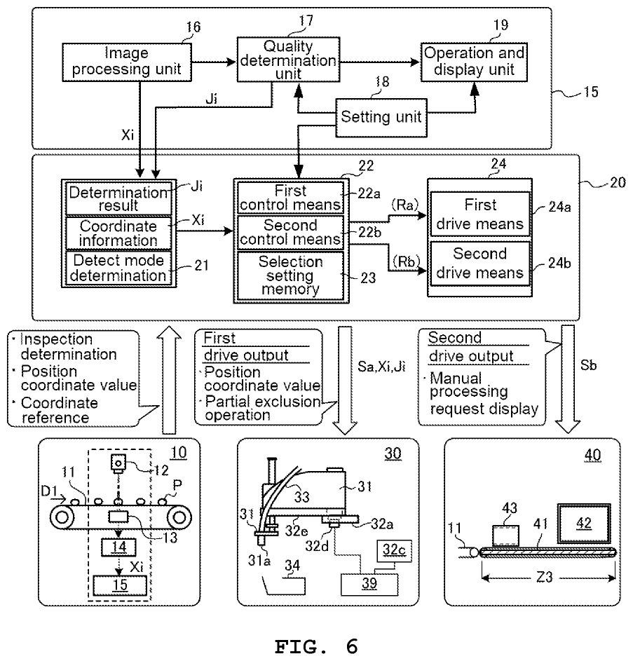

Specifically, as illustrated in FIGS. 2 and 6, the article inspection apparatus 10 emits X-rays from an X-ray irradiation unit 12 to each article P to be inspected transported by the article transport path 11, causes an X-ray line sensor 13 to measure the amount of transmitted X-rays at predetermined time intervals, and sequentially stores the measured values in an image memory 14 while the article P passes through the inspection region, so that an inspection control unit 15 can acquire X-ray inspection image data Xi representing a transmission X-ray amount distribution of the article P.

The inspection control unit 15 has a processor or a memory, as well as various control programs that enable a predetermined function to be exhibited with the processor or the memory therein, and is configured to include an image processing unit 16 that performs an image processing function based on the X-ray inspection image data Xi from the image memory 14, a quality determination unit 17 that performs a function of determining a quality state of the article P based on the image processing result of the image processing unit 16, an operation and display unit 19 such as a touch panel capable of a display or an operation input of the determination result of the quality determination unit 17, and a setting unit 18 capable of setting an operation condition of the image processing unit 16, the quality determination unit 17, and the operation and display unit 19 based on the operation input from the operation and display unit 19.

For example, when the article P conveyed on the article transport path 11 is detected by an article detection sensor (not illustrated), the inspection control unit 15 sets the article P as an article to be inspected based on the detection signal, and causes the X-ray irradiation unit 12 to operate while the article P passes through a specific position (for example, detection position of the line sensor 13) in the inspection section Z1.

The quality determination unit 17 can determine, for example, the quality state of the article P for each predetermined inspection unit region (article P within a predetermined transport distance section) based on the image processing result of the image processing unit 16, and determine whether a foreign substance is included in each inspection unit region.

The additional processing control unit 20 includes a quality state determination unit 21 (determination means) that determines a quality state, for example, a non-defect mode or a defect mode of the article P of which the inspection result is not a non-defective product (also referred to as the defect-determined article P), a processing request selection unit 22 (processing request selection means) that controls whether additional processing, which will be described later, is to be executed by a working machine or manually in a switchable manner according to the determination result of the quality state determination unit 21, a selection setting memory 23 (memory) that stores a condition for selecting the additional processing by the processing request selection unit 22, and a drive processing unit 24 that executes an output of a drive control signal Sa as a work command to a robot working machine 30 for mechanically executing the additional processing, which will be described later, or an output of a display drive control signal Sb to a display 42 on a manual step worktable 40, based on a control signal Ra or Rb from the processing request selection unit 22.

The additional processing control unit 20 is configured with, for example, a management PC and a programmable logic controller (PLC), and incorporates various control programs that enable a predetermined function to be exhibited by using the management PC and the PLC. Further, the additional processing control unit 20 can execute monitoring of a state of the article inspection system 1, managing of the inspection result of the article inspection apparatus 10 associated with a production plan, and drive control of the robot working machine 30 or display drive control on the manual step worktable 40, according to the inspection result of the article inspection apparatus 10, and the like. Further, the additional processing control unit 20 may include a tablet-type information terminal that functions as a programming tool or a setting input switcher for the PLC in cooperation with the management PC.

The quality state determination unit 21 specifies position coordinates and a range of a defective portion of the additional processing requiring article Pj from the X-ray inspection image data Xi, and detects, for example, a type, a size, a shape, a density, a position, the number, the presence or absence of a foreign substance, and the like of defective portions to determine which one of a plurality of preset defect modes the defective portion corresponds to. In addition, when the foreign substance is detected in the article P, the quality state determination unit 21 determines which one of the plurality of defect modes the foreign substance corresponds to, based on the type, the size, the shape, the density, or a contamination position of the foreign substance. Further, in a case where weighing or mass inspection is executed by the article inspection apparatus 10, when an excess or shortage of a content quantity of the article P is detected, based on detection information on an excess or shortage state of the content quantity, the quality state determination unit 21 can determine which one of the plurality of defect modes the excess or shortage of the content quantity corresponds to.

The processing request selection unit 22 has a function of acquiring the X-ray inspection image data Xi and quality determination result Ji as well as the determination result of the quality state determination unit 21 for each inspected article P, and determining whether or not each article P having the quality determination result Ji indicating that the article P is out of a non-defective product for a required predetermined quality state is the additional processing requiring article Pj requiring additional processing such as correction processing of a defective portion according to a product type or a processing state.

In addition, for each additional processing requiring article Pj, the processing request selection unit 22 determines which one of the plurality of types of preset defect modes a defect mode of a defective portion corresponds to, discriminates whether the defect mode is appropriate for additional processing in an automatic step by, for example, the robot working machine 30 to be described later or appropriate for additional processing in a manual step on the manual step worktable 40 to be described later according to the determination result, and outputs the control signals Ra and Rb different from each other according to the determination result.

Specifically, the processing request selection unit 22 has a function of selecting whether to execute the additional processing in the automatic step by the robot working machine 30 (working machine) in a first additional processing section Z2 on a downstream side of the predetermined inspection section Z1 on the article transport path 11, or to execute the additional processing in the manual step in a second additional processing section Z3 on a downstream side of the first additional processing section Z2 by using the manual step worktable 40 according to the determination result of the defect mode of the defective portion of the additional processing requiring article Pj, and includes first control means 22a and second control means 22b for outputting a control command corresponding to the additional processing to the selected additional processing step side.

Here, the first control means 22a outputs the control signal Ra requesting the robot working machine 30 to perform the additional processing in the automatic step, and the second control means 22b outputs the control signal Rb for notifying of the additional processing in the manual step on the manual step worktable 40.

Specifically, the first control means 22a is connected to a robot controller 39 of the robot working machine 30 via first drive means 24a of the drive processing unit 24 constituting a drive circuit. Therefore, the first control means 22a can output the control signal Ra requesting the additional processing in the automatic step to the first drive means 24a, and cause the first drive means 24a to output the drive control signal Sa corresponding to the additional processing in the automatic step by the robot working machine 30 to the robot controller 39.

Further, in a case where the control command from the first control means 22a is not output for the additional processing requiring article Pj, the second control means 22b outputs the control signal Rb for notifying that the additional processing in the manual step by using the manual step worktable 40 is required to the second drive means 24b of the drive processing unit 24 when the additional processing requiring article Pj on which the additional processing in the automatic step by the robot working machine 30 is not executed in the first additional processing section Z2 enters the second additional processing section Z3. By outputting the display drive control signal Sb to the display 42 on the manual step worktable 40 via the second drive means 24b, at least the screen display on the display 42 executes a screen display output as a notification output for requesting the execution of the manual additional processing. The notification output referred to in the following description includes not only a notification output from a notification device such as the display 42 for operators Wk1 and Wk2, but also the control signal Rb from the second control means 22b to the second drive means 24b of the drive processing unit 24 or the display drive control signal Sb from the second drive means 24b based on the output.

The processing request selection unit 22 also stores priority setting information for preferentially selecting any one of first processing request information and second processing request information depending on which one of the plurality of different defect modes that can occur for each inspection item the inspection result of the article inspection apparatus 10 corresponds to, in the selection setting memory 23.

This selection setting memory 23 is incorporated in the processing request selection unit 22, and when the processing request selection unit 22 selects additional processing according to the quality state of the inspected article P, setting information for an additional processing step having a priority according to the quality state can be extracted.

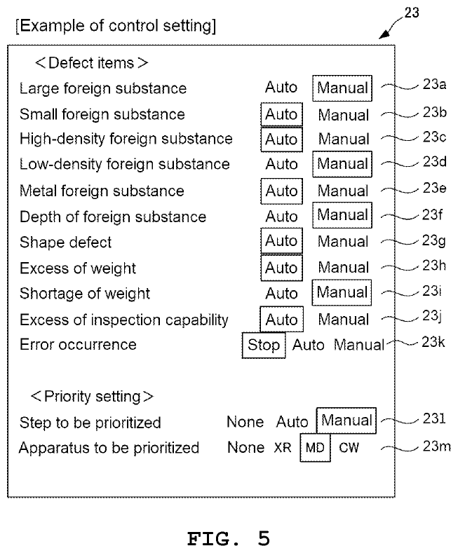

Specifically, for each type of article P, as illustrated in FIG. 5, for example, based on a setting input from the setting unit 18, for a plurality of inspection items 23a to 23k, the selection setting memory 23 stores selection setting information as to whether a priority is given to the additional processing in the automatic step by the robot working machine 30 or the priority is given to the additional processing in the manual step on the manual step worktable 40 according to the inspection result for each inspection item such that the selection setting information can be displayed as a list and set and changed, on at least the operation and display unit 19 of the article inspection apparatus 10 or/and on the display 42 on the manual step worktable 40.

The drive processing unit 24 includes the first drive means 24a for outputting a work command for an automatic step to the robot working machine 30 as the drive control signal Sa based on the control signal Ra from the processing request selection unit 22, and the second drive means 24b for outputting the display drive control signal Sb to the display 42 on the manual step worktable 40 based on the control signal Rb from the processing request selection unit 22.

When a first additional control condition preset by the setting unit 18 is satisfied based on the result of the inspection by the article inspection apparatus 10, the drive processing unit 24 operates the first drive means 24a by the control signal Ra under this condition, and outputs a control command for automatically, partially, and mechanically excluding a defective portion of the additional processing requiring article Pj to the robot working machine 30.

A rotary encoder (not illustrated) is attached to a conveyor constituting the article transport path 11, and the additional processing control unit 20 can calculate a position of each article P which is to be inspected or already inspected in the transport direction D1 together with position coordinates of a defective portion to be partially excluded by the robot working machine 30, by acquiring an encoder pulse for each constant transport distance of the article transport path 11. Further, in a period when the inspected article P which is determined as the additional processing requiring article Pj enters the first additional processing section Z2 in which a defective portion can be partially excluded by the robot working machine 30, the additional processing control unit 20 can sequentially calculate a transport position of the additional processing requiring article Pj, a relative position with a tip portion of the robot working machine 30 in a horizontal direction, or the like.

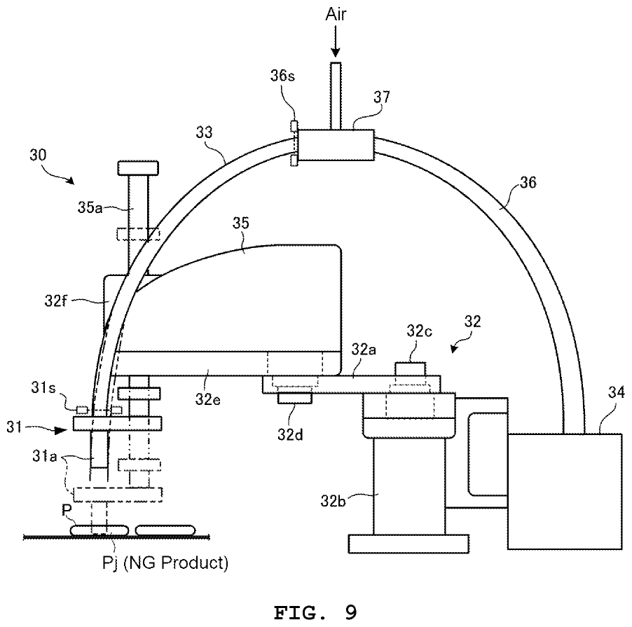

As illustrated in FIG. 9, the robot working machine 30 has a cutting-out head 31 that also serves as a suction sorting head. The cutting-out head 31 can be moved at least in a transport path width direction orthogonal to the article transport direction (longitudinal direction of the line sensor 13) by an articulated robot arm 32, here, in both directions of an article transport direction and the transport path width direction by the horizontal articulated robot arm 32, and can be discharged to a defective product storing bin 34 outside the article transport path 11 (hereinafter, also referred to as outside the system). The cutting-out head 31 has a nozzle 31a with a cylindrical cutting blade. By lowering the nozzle 31a to surround a defective portion of the additional processing requiring article Pj, the defective portion of the additional processing requiring article Pj can be cut out or scraped away.

An actuator, such as the robot working machine 30, for automatically executing additional processing is selected according to a shape or a characteristic of the article P to be handled, and is not particularly limited. For example, the actuator may be a motor that drives a robot hand, may be an electromagnetic valve that applies a pneumatic suction force to a tip of the nozzle 31a, may be an air cylinder that moves one end of a belt conveyor up and down, or may be anything else.

When a second additional control condition preset by the setting unit 18 is satisfied based on the result of the inspection by the article inspection apparatus 10, the drive processing unit 24 operates the second drive means 24b by the control signal Rb under this condition, and notifies that at least manual additional processing is required by a display drive output with the display 42 (display device and notification device) on the manual step worktable 40. Of course, another notification output such as an audio output may be performed at a time of notification by the display 42.

Here, the manual step worktable 40 is disposed on a downstream side of the robot working machine 30 in the predetermined transport direction D1. When the display 42 or the like outputs the notification that manual additional processing is required, based on the result of the inspection by the article inspection apparatus 10 and the displays of the additional processing requiring article Pj and its defective portion on the X-ray inspection image data Xi, the additional processing such as manually partial exclusion of the defective portion can be executed on the article P inspected by the article inspection apparatus 10, in the second additional processing section Z3 by a predetermined transport distance.

This manual step worktable 40 includes, for example, a two-person worktable 41 located on one side of the second additional processing section Z3 on the article transport path 11, the display 42 located on the other side of the second additional processing section Z3, and a pusher 43 that immediately pushes out the additional processing requiring article Pj that enters the second additional processing section Z3 on which additional processing in the automatic step by the robot working machine 30 is not executed in the first additional processing section Z2 to an upstream end side (a side of the operator Wk1 who executes the additional processing) on the worktable 41 immediately after the entering.

In a case where a defective portion of the article P pushed onto the worktable 41 is displayed on a screen on the display 42, a reference line or a grid may be displayed on the worktable 41 to facilitate specifying of a position on the worktable 41. In addition, even in a case where the robot working machine 30 does not execute the additional processing in the automatic step in the first additional processing section Z2, a lowering position of the cutting-out head 31 of the robot working machine 30 may be reduced to a predetermined marking height, and the additional processing requiring article Pj on which preliminary marking work is executed may be moved onto the worktable 41. Further, a rotary indexable mechanism or a hand may be mounted on the tip portion of the robot working machine 30 to which the cutting-out head 31 is mounted, so that the cutting-out head 31 and a dedicated marking head may be used interchangeably. Needless to say, a type of marking and the presence or absence of suction on the cutting-out head 31 side during marking can be easily operated by valve control.

In the article inspection system 1, the additional processing control unit 20 is connected to the robot working machine 30 and the manual step worktable 40 via a LAN by a predetermined communication method such that the X-ray inspection image data Xi and the quality determination result Ji for each inspected article P can be input from the inspection control unit 15 built in the article inspection apparatus 10, and a control command can be output to the robot controller 39 of the robot working machine 30 and the display 42 of the manual step worktable 40 via the drive processing unit 24. The LAN referred to here is configured with, for example, an Ethernet-based fieldbus, and can be used for digital communication between controllers (communication for exchange of control information in a lower layer, monitoring of an operation situation of the lower layer by an upper layer or events in each device, or the like).

The cutting out or scraping away of the defective portion by the cutting-out head 31 of the robot working machine 30 is a local removal operation for the articles P spread in the first additional processing section Z2 on the article transport path 11, and is a removal operation for removing a part of the article P spread on the article transport path 11 from the article transport path 11 to an outside.

When the robot working machine 30 partially excludes the defective portion, the additional processing control unit 20 acquires the inspection determination result of the quality determination unit 17 and position information for the additional processing requiring article Pj from the inspection control unit 15 of the article inspection apparatus 10, and acquires the X-ray inspection image data Xi together with its coordinate reference data. Further, the additional processing control unit 20 executes control of synchronizing the operations of the article inspection apparatus 10 and the robot working machine 30 such that while the additional processing requiring article Pj moves from the inspection section Z1 by the article inspection apparatus 10 to the first additional processing section Z2, which is an operation area for partial exclusion by the robot working machine 30, coordinates of the inspection unit region including the defect determination portion in the X-ray inspection image data Xi of the additional processing requiring article Pj and a position change accompanying its transportation are linked, and a position of the partial exclusion operation by the robot working machine 30 coincides with coordinates of the defective portion determined as a defect by the quality determination unit 17 of the article inspection apparatus 10.

As illustrated in FIGS. 5, 6, and 9, the cutting-out head 31 includes, for example, the elevating nozzle 31a having a downward opening at a lower end portion and a cylindrical cutting edge portion, a head main body 35 for supporting the nozzle 31a to be vertically driven via an elevating drive shaft 35a, a flexible suction duct 33 connected to an upper end portion of the nozzle 31a, a drive fluid ejection unit 37 having an ejector function of ejecting a high-pressure drive fluid (here, air, which is compressed air) from a periphery of an outlet of the suction duct 33 toward the downstream side to generate a negative pressure in the suction duct 33, and a flexible discharge duct 36 connected to an outlet side of the suction duct 33 and the drive fluid ejection unit 37 and forming a diffuser passage of gradually increasing an internal passage cross-sectional area toward the defective product storing bin 34. The cutting-out head 31 can suck the defective portion of the additional processing requiring article Pj from the nozzle 31a into the suction duct 33, and discharge the defective portion from the discharge duct 36 to the defective product storing bin 34.

As illustrated in FIG. 3 or FIG. 4, when the exclusion portion including the defective portion of the additional processing requiring article Pj is sucked by the nozzle 31a, or when the exclusion portion is sucked and passes through the inlet, the exclusion portion is detected by a small passage detection sensor 31s such as a reflective laser sensor mounted on an upstream end portion side of the nozzle 31a or the suction duct 33. Further, when the exclusion portion is sucked into the suction duct 33 and passes to a discharge side, the exclusion portion is detected by a passage detection sensor 36s mounted on a downstream end portion side of the suction duct 33 or in the vicinity of the drive fluid ejection unit 37.

The nozzle 31a of the cutting-out head 31 can be moved up and down between a raising position indicated by a solid line in FIG. 9 and a lowering position indicated by a virtual line in FIG. 9 via the elevating drive shaft 35a by an elevating drive mechanism 32f integrally supported by a second arm 32e together with the head main body 35, and a height of the lowering position is set for each product type of the article P such that the defective portion of the additional processing requiring article Pj can be pinpointed and sucked on the raising position side and partially removed outside the article transport path 11 (hereinafter, also referred to as outside the system).

In the robot arm 32, for example, a base end portion of the first arm 32a is rotatably supported onto a support table 32b and is rotatably driven via a geared motor 32c, and the second arm 32e is rotatably supported to be driven via a joint portion having a geared motor 32d at a tip portion of the first arm 32a. The second arm 32e integrally supports the cutting-out head 31, and can move the nozzle 31a to any coordinate position within a movable region, by controlling each drive angular position of the geared motors 32c and 32d to a target value by servo control of the robot controller 39.

Needless to say, the robot arm 32 may be equipped with holding means for holding the nozzle 31a in any posture on a tip side of the second arm 32e. That is, the robot arm 32 not only functions as moving means for moving the nozzle 31a, but also may tilt the nozzle 31a slightly with respect to a direction of a line of sight (for example, vertical direction V) of an X-ray inspection image when sucking and excluding the defective portion of the additional processing requiring article Pj with a joint mechanism or the like on a wrist side.

In this manner, in the robot working machine 30, among a plurality of articles P on the article transport path 11, a defective portion of the additional processing requiring article Pj as a specific inspection result, which is not a non-defective product by the determination processing of the X-ray inspection image data Xi can be cut out and sucked up by the nozzle 31a having a height, a horizontal position, or a posture corresponding to the X-ray inspection image data Xi, and excluded to the outside of the article transport path 11.

Further, the additional processing control unit 20 sets a position in the horizontal direction of a center of an opening of the nozzle 31a (opening center position) at the start of the suction of the additional processing requiring article Pj to a predetermined height on the coordinates of the defective portion of the additional processing requiring article Pj. Further, the additional processing control unit 20 successively sets target coordinates (x, y, z) of a movement destination according to the coordinates during the transport of the additional processing requiring article Pj, and horizontally moves the nozzle 31a having a cylindrical cutting blade function while causing the drive fluid ejection unit 37 to exhibit an ejector function to the target coordinate, and then lowers the nozzle 31a to the target coordinates to the vicinity of a transport path surface height to cut out and suck a defective portion of the additional processing requiring article Pj together with a portion in the vicinity of the defective portion, for example, in a circular shape and partially exclude the defective portion. Depending on a range and the number of defective portions of the additional processing requiring article Pj, such partial exclusion can be performed a plurality of times for the same additional processing requiring article Pj.

In addition, when specifying a defective portion of the additional processing requiring article Pj, the additional processing control unit 20 has a function of executing noise removal filter processing for executing noise reduction processing such as smoothing on, for example, the X-ray inspection image data Xi, and edge enhancement filter processing for detecting, in a case where there is a defective portion in the article P, a sharp change in transmission X-ray density around the defective portion, belt conveyor speed setting processing for determining a workpiece transport speed, and the like.

Alternatively, depending on a product type or an inspection item of the article P, the additional processing control unit 20 can perform binarization or labeling processing of the X-ray inspection image data Xi, or measure a thickness in consideration of a density distribution of the X-ray transmission image or calculate a center position of gravity, and may set an exclusion target range for partially excluding the defective portion in consideration of these results.

In this manner, the article inspection system 1 includes the article inspection apparatus 10 that inspects the article P being transported within the predetermined inspection section Z1, and the additional processing control unit 20 that selectively executes predetermined additional processing on the inspected additional processing requiring article Pj according to the inspection result of the article inspection apparatus 10. The additional processing control unit 20 has an additional processing control function of determining and selecting, when the additional processing requiring article Pj which is determined to be excluded from a non-defective product as an inspection result of the article inspection apparatus 10 occurs, whether a defect mode of the additional processing requiring article Pj is appropriate for mechanical additional processing by the robot working machine 30 or appropriate for manual additional processing using the manual step worktable 40.

In addition, the article inspection system 1 can execute automatic mechanical correction processing of pinpointing and partially excluding an exclusion target portion with a predetermined radius including a defective portion of the additional processing requiring article Pj in the first additional processing section Z2 by operating the robot working machine 30 in response to the control signal Ra from the additional processing control unit 20, and notify the operators Wk1 and Wk2 that manual additional processing is requested by displaying and driving the display 42 on the manual step worktable 40 according to the control signal Rb from the additional processing control unit 20 as an output. The latter operator Wk2 of the operators Wk1 and Wk2 is, for example, a worker who monitors a manual step during the additional processing or checks additional processed products, and the additional processed products can be arranged according to a manual work load.

In this manner, in the article inspection system 1 of the present embodiment, when the processing request selection unit 22 selects the first processing request information requesting the additional processing in the automatic step, a predetermined work operation for removing an abnormal portion in a quality state from the additional processing requiring article Pj for which an abnormality is detected in the quality state is executed on the robot working machine 30. Meanwhile, when the processing request selection unit 22 selects the second processing request information requesting the additional processing in the manual step, based on the second processing request information, the display 42 notifies and outputs a work request for the second manual additional processing.

The processing request selection unit 22 refers to a selection setting condition stored in the selection setting memory 23, for example, priority setting information on whether the automatic step or the manual step is required, which is set according to an inspection result for each inspection item as illustrated in FIG. 5, according to the inspection result by the article inspection apparatus 10 and the quality state of the inspected article P. The processing request selection unit 22 determines whether or not the first additional control condition for giving a priority to the automatic step is satisfied, and determines whether or not a second additional processing condition for giving a priority to the manual step is satisfied based on the selection setting condition stored in the selection setting memory 23 when the first additional control condition is not satisfied. When neither the first nor second additional control conditions is satisfied, a system error or the like occurs, or the quality state of the inspected article P is appropriate and no additional processing is required. When an abnormality such as the system error or the like occurs, the system is stopped, and in a case where the quality state of the article P is appropriate and no additional processing is required, for example, the automatic step is not executed, and the manual step is monitored by the operator Wk2.

The first additional control condition referred to here is a condition in which the partial exclusion operation of cutting-out by the robot working machine 30 can be accurately executed in an automatic additional processing region E in which the robot working machine 30 can perform a partial exclusion operation of pinpointing and cutting-out, in particular, a plurality of processing determination sections Z2a of which an entity is included in the automatic additional processing region E, or further even within a plurality of leading sections Z2a′ before and after of which a full width in the transport direction is included in the automatic additional processing region E. Further, the second additional processing condition is a condition in which the manual additional processing work can be performed in a case where the first additional processing condition is not satisfied.

In addition, “priority setting” 23l and 23m in FIG. 5 is to preset processing to be prioritized in a case where the inspection results for a plurality of inspection items for the same additional processing requiring article Pj are generated and conflict with each other. A prioritized step 23l is, for example, a manual step, and an apparatus prioritized as the article inspection apparatus 10 is, for example, a metal detector marked MD numbered by 23m in FIG. 5. The symbol XR in FIG. 5 means an X-ray inspection system such as an X-ray foreign object detector, and CW means a checkweigher.

When there is no need to dynamically select and set additional processing to be prioritized during the operation, whether the robot working machine 30 is mainly used or the manual step worktable 40 is mainly used may be variably set manually or depending on an automatic mode setting or the like according to the type of article P.

The cutting-out head 31 of the robot working machine 30 can also serve as pinpoint exclusion means for sucking a specific article having an inspection result of being excluded from a predetermined quality condition, such as a defective product, for example, among the inspected articles P, and excluding the specific article from the article transport path 11. When the inspection result by the article inspection apparatus 10 is out of the predetermined quality condition, by being supported by the robot arm 32, the cutting-out head 31 operates as an exclusion head which moves at least in a direction orthogonal to the predetermined transport direction D1 according to the inspection result, here, in both the transport direction D1 of the article transport path 11 and a width direction w orthogonal to the transport direction D1.

Since the robot arm 32 is used for the robot working machine 30, the automatic additional processing region E illustrated in FIG. 7 is set within a predetermined radius R1 from a center O1 located on one side of the article transport path 11 in the width direction w. This predetermined radius R1 is set to be larger than a width of a road surface of the article transport path 11, and satisfied such that at each determination point of the additional processing condition by the processing request selection unit 22, a predetermined number of processing determination sections Z2a on the downstream side of the article inspection apparatus 10 are always included completely in the automatic additional processing region E.

On a condition in which the predetermined number of processing determination sections Z2a within the automatic additional processing region E are satisfied, the additional processing control unit 20 executes control such that the article P (NG product) determined to be defective does not remain in the leading section Z2a′ of which a part or an entity is out of a downstream side of the automatic additional processing region E, and the article P (NG product) determined to be defective which is included in the predetermined number of processing determination sections Z2a in the automatic additional processing region E and an NG product included in a following section Z2a″ in the automatic additional processing region E are pinpointed and excluded by the robot working machine 30.

Next, the actions will be described.

In the present embodiment configured as described above, in a production line of products including the plurality of articles P, the article inspection apparatus 10 sequentially executes article inspection on the articles P on the article transport path 11 by a predetermined inspection method. When the first additional processing condition is satisfied, the defective portion of the additional processing requiring article Pj is partially excluded by pinpointing and cutting-out in the automatic additional processing step by the robot working machine 30, or when the second additional processing condition is satisfied on a downstream side of the robot working machine 30, in the manual step on the manual step worktable 40, the defective portion of the additional processing requiring article Pj is partially excluded in the manual additional processing or other correction processing is performed.

At this time, the processing request selection unit 22 of the additional processing control unit 20 determines whether or not the first additional control condition is satisfied based on the selection setting condition of the preferential additional processing stored in the selection setting memory 23. In a case where the first additional control condition is not satisfied, the processing request selection unit 22 determines whether or not the second additional processing condition is satisfied. According to any determination result, the control signal Ra requesting pinpointing and partial exclusion in the automatic step by the robot working machine 30 or the control signal Rb requesting additional processing by manual work on the manual step worktable 40 is output, and the additional processing conditions are switched according to the inspection result of each article P.

In the article inspection system 1 of the present embodiment, the quality state determination unit 21, which is determination means of the additional processing control unit 20, determines which one of a plurality of preset quality states the inspection result of the article inspection apparatus 10 corresponds to. The processing request selection unit 22 selects any one of the first processing request information requesting the robot working machine 30 to perform first additional processing work and the second processing request information requesting second manual additional processing work with a notification output according to the determination result of the quality state determination unit 21 to output an additional processing request.

Therefore, if the quality state can be fully handled in the automatic additional processing by the robot working machine 30, highly reliable additional processing can be executed to sufficiently reduce a load for manual additional processing. If the quality state is desirable to be manually checked, corrected, or the like, the automatic additional processing by the robot working machine 30 is omitted or reduced to preliminary processing, and accurate manual additional processing on the manual step worktable 40 can be executed with a low load.

Further, in the present embodiment, for a plurality of inspection items that can be inspected by the article inspection apparatus 10, a condition for selecting the first processing request information or the second processing request information by the processing request selection unit 22 is preset and stored in the selection setting memory 23, so that as the request information for additional processing corresponding to each inspection result for the plurality of inspection items, it is possible to accurately select and set whether to give a priority to the automatic step by the robot working machine 30 or to give a priority to the manual additional processing on the manual step worktable 40.

Further, in the present embodiment, when the article inspection apparatus 10 detects at least an abnormality in the quality state of the article, the quality state determination unit 21 determines which one of a plurality of defect modes preset based on the quality state of the article the abnormality corresponds to. Therefore, it is possible to accurately determine the defect mode corresponding to a content of the abnormality in the quality state of the additional processing requiring article Pj, and to quickly and accurately select additional processing required for the defect mode.

In addition, in the present embodiment, when a foreign substance is detected in the article P, the quality state determination unit 21 determines which one of the plurality of defect modes the foreign substance corresponds to, based on a type, a size, a shape, a density, or a contamination position of the foreign substance. Therefore, it is possible to accurately select a selection setting appropriate to additional processing such as partial exclusion for a defect mode in which the additional processing requiring article Pj includes a foreign substance.

Further, in the present embodiment, when an excess or shortage of a content quantity of the article P is detected, the quality state determination unit 21 can determine which one of the plurality of defect modes the excess or shortage of the content quantity corresponds to, based on an excess or shortage state of the content quantity. Therefore, it is possible to quickly and accurately select the additional processing appropriate to the excess or shortage of the content quantity.

Further, in the present embodiment, the processing request selection unit 22 stores the priority setting information for preferentially selecting any one of the first processing request information and the second processing request information depending on which one of the plurality of different quality states that can occur for each inspection item the inspection result of the article inspection apparatus 10 corresponds to, in the selection setting memory 23. Therefore, when the processing request selection unit 22 selects a request for additional processing, it is quickly and accurately determined whether a priority is given to the automatic step or to the manual step, based on the information stored in the selection setting memory 23.

Further, in the present embodiment, when the processing request selection unit 22 selects and outputs the control signal Ra, which is the first processing request information, the additional processing control unit 20 causes the robot working machine 30 to execute a predetermined work operation for removing an abnormal portion of a quality state from the additional processing requiring article Pj for which the abnormality is detected in the quality state. When the processing request selection unit 22 selects and outputs the control signal Rb, which is the second processing request information, the additional processing control unit 20 notifies and outputs a work request for the second manual additional processing in the display 42 on the manual step worktable 40 based on the second processing request information.

Therefore, reliability of the additional processing by the robot working machine 30 can be improved, and a load for the manual additional processing on the manual step worktable 40 can be reduced. Meanwhile, when a quality state requiring manual checking or manual correction processing occurs, it is possible to quickly and accurately notify an operator of the quality state.

In the present embodiment, the additional processing in the automatic step by the robot working machine 30 is partial exclusion work of cutting out the defective portion. In a case where the working machine is used for the additional processing of removing or correcting the defective portion in the quality state from the additional processing requiring article Pj such as a defective product, not only the working machine can be used to execute a mechanical removal operation or the like on the defective portion, but also other preliminary additional processing or the like for marking the defective portion or cutting to expose the defective portion to the outside is executed according to the control signal Ra, which is the first processing request information, and then main additional processing such as manual correction processing for the defective portion can be executed after the other preliminary additional processing or the like.

That is, the first processing request information and the second processing request information referred to in the present invention may be used for selecting automatic work by the working machine or manual work at the time of the additional processing, and accurately distribute the inspected article P to the working machine or the operator. In order to improve the reliability of the additional processing and reduce the load, the additional processing may be performed by using both the preliminary processing by the working machine and the main processing such as manual correction processing.

For example, in a case where it is not easy for the operator to visually recognize a defective portion of the inspected article P that is a raw material for processed food or the like since the defective portion is not exposed on an outer surface of the article P, it is also possible to perform preliminary work for facilitating the manual additional processing work, by performing cutting to expose the defective portion from the surface of the article or marking the defective portion by preliminary additional processing work of the working machine.

As described above, with the article inspection system of the present embodiment, it is possible to provide an article inspection system capable of surely reducing the load of the manual checking, the manual correction processing, or the like on the manual step worktable 40, and sufficiently reducing the additional processing load while increasing the reliability of mechanical additional processing in the automatic step by the robot working machine 30.

In the embodiment described above, the additional processing control unit 20 is a control device independent of the inspection control unit 15 of the article inspection apparatus 10 and the robot controller 39 of the robot working machine 30. Meanwhile, the control device according to the present invention may be configured as an integrated control unit in which the functions of the inspection control unit 15, the robot controller 39, and the like are distributed, or may not be provided with an independent control unit. Further, the manual step worktable 40 to which the articles P in the second additional processing section Z3 by the predetermined transport distance is discharged to the outside of the system according to the inspection result is set as a part of the conveyor on the article transport path 11, and additional processing in the automatic step by the robot working machine 30 is not executed in the first additional processing section Z2 and the additional processing requiring article Pj entering the second additional processing section Z3 is pushed onto the worktable 41 by the pusher 43. Meanwhile, it is needless to say that the distributing means to the manual operators can take any form. The additional processing requiring article Pj as a manual additional processing target may be dropped onto the worktable 41 by, for example, an up-out discharge method, a drop-down method, a shuttle method, a shoot method, or the like, and the additional processing requiring article Pj may be returned to the article transport path 11 side after the additional processing.

As described above, in the article inspection system 1, the additional processing control unit 20, which receives inspection information from the article inspection apparatus 10 and controls additional processing, includes the processing request selection unit 22 that outputs the control information Ra and Rb for requesting additional processing based on control settings, the drive processing unit 24 that receives the control information Ra and Rb and outputs the predetermined actuator drive control signal Sa and display drive control signal Sb, and the selection setting memory 23 for setting and storing the selection setting information in the processing request selection unit 22, and causes the processing request selection unit 22 to output the control signals Ra and Rb requesting a setting of an output form of the control information according to the inspection information to the drive processing unit 24. The drive processing unit 24, which receives the control signals Ra and Rb, causes the first drive means 24a, which receives one control signal Ra, to output the first drive control signal Sa for actuator drive control, and causes the second drive means 24b of the drive processing unit 24, which receives the other control signal Rb, to output the second drive control signal Sb for display drive control of the display 42. That is, for the plurality of defect modes of the plurality of inspection items inspected by the article inspection apparatus 10, depending on whether to output the first control information Sa or the second control information Sb, it is possible to dynamically switch between a setting of the additional processing in the automatic step and the additional processing in the manual step.

When a plurality of defect items are duplicated as the article inspection result, a selection condition for the additional processing step or the inspection step with a priority is further set and stored in the selection setting memory 23 such that one of the first control information Ra and the second control information Rb can be preferentially output according to the control setting.

Thus, the additional processing requiring article Pj that can be processed in the automatic step such as a robot or a sorting device and the additional processing requiring article Pj that requires manual work such as visual checking or removal work are conveyed out to a convey destination preferentially set in advance for each defect item. Therefore, different additional processing steps can be set for different additional processing requiring articles Pj, and assignment of operators can be optimized based on these settings. In addition, it is possible to promote labor saving by introducing production equipment step by step, and improvement of investment efficiency can be expected.

As described above, the present invention provides an article inspection system with high reliability that reduces a load required for manual checking or manual correction processing, and sufficiently reduces an additional processing load, while increasing reliability of automatic additional processing by a working machine. The present invention is generally useful in an article inspection system including an article inspection unit and an additional processing control unit that executes additional processing on an inspected article according to the inspection result.

### DESCRIPTION OF REFERENCE NUMERALS AND SIGNS

1 Article inspection system
10 Article inspection apparatus
11 Article transport path
12 X-ray irradiation unit
13 X-ray line sensor (X-ray detector)
14 Image memory
15 Inspection control unit
16 Image processing unit
17 Quality determination unit
18 Setting unit
19 Operation and display unit
20 Additional processing control unit
21 Quality state determination unit (determination means of quality state, determination means of defect mode)
22 Processing request selection unit (processing request selection means)
22a First control means
22b Second control means
23 Selection setting memory (memory, selection setting information storage means for prioritized additional processing)
24 Drive processing unit
24a First drive means
24b Second drive means
30 Robot working machine
31 Cutting-out head
31a Nozzle (cylindrical cutting edge portion)
31s Passage detection sensor
32 Robot arm
32a First arm
32b Support table
32c, 32d Geared motor
32e Second arm
32f Elevating drive mechanism
33 Suction duct
35 Head main body
35a Elevating drive shaft
36 Discharge duct
36s Passage detection sensor
37 Drive fluid ejection unit
39 Robot controller
40 Manual step worktable
41 Worktable
42 Display (display device, notification device)
43 Pusher
D1 Transport direction (predetermined transport direction)
O1 Center (rotation center of arm of robot working machine)
R1 Predetermined radius (radius of work region of robot working machine)
Ra Control signal (first processing request information, additional processing request in automatic step, selection request of automatic additional processing by working machine)
Rb Control signal (second processing request information, additional processing request in manual step, selection request of manual additional processing)
Wk1 Operator (worker for additional processing)
Wk2 Operator (worker for monitoring and checking)
Z1 Inspection section (predetermined inspection section)
Z2 First additional processing section
Z2a Processing determination section
Z2a′ Leading section
Z2a″ Following section
Z3 Second additional processing section

What is claimed is:

1. An article inspection system comprising:
an article inspection unit that inspects a transported article; and
an additional processing control unit that executes additional processing on an article determined to be defective among inspected articles, according to an inspection result of the article inspection unit,
wherein the additional processing control unit includes
a quality state determination unit that determines which one of a plurality of preset quality states the inspection result of the article inspection unit corresponds to, and
processing request selection means for selecting any one of first processing request information for requesting a working machine to perform first additional processing work by the working machine and second processing request information for requesting second manual additional processing work, according to a determination result of the quality state determination unit.

2. The article inspection system according to claim 1,
wherein for a plurality of inspection items which are inspectable by the article inspection unit, the processing request selection means presets a condition for selecting the first processing request information or the second processing request information.

3. The article inspection system according to claim 1,
wherein when the article inspection unit detects at least an abnormality in a quality state of the article, the quality state determination unit determines which one of a plurality of defect modes the abnormality corresponds to, based on the quality state of the article.

4. The article inspection system according to claim 2,
wherein when the article inspection unit detects at least an abnormality in a quality state of the article, the quality state determination unit determines which one of a plurality of defect modes the abnormality corresponds to, based on the quality state of the article.

5. The article inspection system according to claim 3,
wherein when a foreign substance is detected in the article, the quality state determination unit determines which one of the plurality of defect modes the foreign substance corresponds to, based on a type, a size, a shape, a density, or a contamination position of the foreign substance.

6. The article inspection system according to claim 4,
wherein when a foreign substance is detected in the article, the quality state determination unit determines which one of the plurality of defect modes the foreign substance corresponds to, based on a type, a size, a shape, a density, or a contamination position of the foreign substance.

7. The article inspection system according to claim 3,
wherein when an excess or shortage of a content quantity of the article is detected, the quality state determination unit determines which one of the plurality of defect modes the excess or shortage of the content quantity corresponds to, based on a state of the excess or shortage of the content quantity.

8. The article inspection system according to claim 4,
wherein when an excess or shortage of a content quantity of the article is detected, the quality state determination unit determines which one of the plurality of defect modes the excess or shortage of the content quantity corresponds to, based on a state of the excess or shortage of the content quantity.

9. The article inspection system according to claim 5,
wherein the processing request selection means stores priority setting information for preferentially selecting any one of the first processing request information and the second processing request information, depending on which one of the plurality of different quality states occurring for each inspection item the inspection result of the article inspection unit corresponds to, in a memory.

10. The article inspection system according to claim 6,
wherein the processing request selection means stores priority setting information for preferentially selecting any one of the first processing request information and the second processing request information, depending on which one of the plurality of different quality states occurring for each inspection item the inspection result of the article inspection unit corresponds to, in a memory.

11. The article inspection system according to claim 7,
wherein the processing request selection means stores priority setting information for preferentially selecting any one of the first processing request information and the second processing request information, depending on which one of the plurality of different quality states occurring for each inspection item the inspection result of the article inspection unit corresponds to, in a memory.

12. The article inspection system according to claim 8,
wherein the processing request selection means stores priority setting information for preferentially selecting any one of the first processing request information and the second processing request information, depending on which one of the plurality of different quality states occurring for each inspection item the inspection result of the article inspection unit corresponds to, in a memory.

13. The article inspection system according to claim 1,
wherein when the processing request selection means selects the first processing request information, the additional processing control unit causes the working machine to execute a predetermined work operation for removing an abnormal portion of the quality state from an article of which an abnormality is detected in the quality state, and when the processing request selection means selects the second processing request information, the additional processing control unit causes a notification device to output a work request for the second manual additional processing, based on the second processing request information.

14. The article inspection system according to claim 2,
wherein when the processing request selection means selects the first processing request information, the additional processing control unit causes the working machine to execute a predetermined work operation for removing an abnormal portion of the quality state from an article of which an abnormality is detected in the quality state, and when the processing request selection means selects the second processing request information, the additional processing control unit causes a notification device to output a work request for the second manual additional processing, based on the second processing request information.
